(19) United States
(12) Patent Application Publication
(10) Pub. No.: US 2022/0168810 A1
(43) Pub. Date: Jun. 2, 2022

(54) THREE-DIMENSIONAL PRINTING SYSTEM THAT MINIMIZES USE OF METAL POWDER

(71) Applicant: 3D Systems, Inc., Rock Hill, SC (US)

(72) Inventors: Jonathan Watson, Santa Monica, CA (US); Kirt Winter, San Diego, CA (US)

(21) Appl. No.: 17/402,783

(22) Filed: Aug. 16, 2021

Related U.S. Application Data
(60) Provisional application No. 63/065,847, filed on Aug. 14, 2020.

(51) Int. Cl. B22F 10/28; B22F 10/85; B33Y 30/00; B33Y 10/00; B33Y 70/00; B33Y 80/00; B22F 1/05

(52) U.S. Cl. CPC B22F 10/28; B22F 10/85; B33Y 30/00; B33Y 10/00; B22F 2304/10; B33Y 80/00; B22F 1/05; B22F 2302/256; B33Y 70/00

(57) ABSTRACT

A three-dimensional (3D) printing system for manufacturing a three-dimensional (3D) article includes a support powder dispenser containing support powder, a metal powder dispenser containing metal powder, a build plate, a beam system, and a controller. The controller is configured to (1) receive information defining a two-dimensional (2D) slice of the 3D article, (2) position the build plate to receive a new layer of metal powder, (3) operate the metal powder dispenser to dispense the new layer of metal powder, the new layer of metal powder spanning the 2D slice and extending beyond the boundaries to define a zone of unfused powder, (4) operate the beam system to selectively fuse the new layer of powder over an area corresponding to the 2D slice, (5) operate the support powder dispenser to dispense a bounding contour of support powder proximate to or overlapping the zone of unfused powder.

### CROSS-REFERENCE TO RELATED APPLICATIONS

This non-provisional patent application claims priority to U.S. Provisional Application Ser. No. 63/065,847, Entitled “THREE-DIMENSIONAL PRINTING SYSTEM THAT MINIMIZES USE OF METAL POWDER” by Jonathan Watson et al., filed on Aug. 14, 2020, incorporated herein by reference under the benefit of U.S.C. 119(e).

### STATEMENT OF GOVERNMENT RIGHTS

This invention was made with government support under Agreement No. W911NF-18-9-000.3 awarded by the U.S. Army Research Laboratory and AMMP Consortium Member Agreement Number 201935 awarded by the National Center for Manufacturing Sciences (NCMS). The government has certain rights in the invention.

### FIELD OF THE INVENTION

The present disclosure concerns an apparatus and method for a layer-by-layer fabrication of three dimensional (3D) articles by selectively fusing metal powder materials. More particularly, the present disclosure concerns a system and method that minimizes use of metal powder while preserving surface quality of the 3D articles.

### BACKGROUND

Three dimensional (3D) printing systems are in rapidly increasing use for purposes such as prototyping and manufacturing. One type of three dimensional printer utilizes a layer-by-layer process to form a three dimensional article of manufacture from powdered metallic materials. Each layer of powdered material is selectively fused using an energy beam such as a laser, electron, or particle beam. One challenge with these systems is a very high cost of metal powder some of which is unfused. Another is an ability to define high resolution and high quality surfaces.

### BRIEF DESCRIPTION OF THE FIGURES

FIG. 1 is a schematic diagram of an embodiment of a three-dimensional (3D) printing system.

FIG. 2 is a flowchart of a first embodiment of a method of fabricating a metallic 3D article.

FIG. 3A is a plan view looking down upon a lateral area of a build plate upon which a bounding contour of support powder has been deposited. The particular pattern of the bounding contour is illustrative only since many other patterns are possible. The illustrated bounding contour includes an outer bounding contour and an inner bounding contour between which is an interior area.

FIG. 3B is similar to FIG. 3A except that a metal powder layer has been deposited over the interior area between the inner and outer bounding contours. In the illustrated embodiment, the unfused metal powder layer has edges that are proximate to or in contact with the bounding contours.

FIG. 3C is similar to FIG. 3B except that a 2D slice area of the metal powder layer has been fused. Between the fused metal powder and the contour is a zone of unfused metal. The zone of unfused metal assures that the area of fused metal does not contain or fuse to any particles of the support powder.

FIG. 4 is a cross-sectional view taken from AA′ of FIG. 3C.

FIG. 5 is a flowchart of a second embodiment of a method of fabricating a metallic 3D article.

FIG. 6A is a plan view looking down upon a lateral area of a build plate upon which a new layer of metal powder has been selectively dispensed. The new layer of metal powder includes an area of a 2D slice of a 3D article and a zone of unfused powder that extends beyond boundaries of the 2D slice to includes a zone having a lateral width of at least an offset distance D.

FIG. 6B is similar to FIG. 6A except that the 2D slice area of the new layer of metal powder has been fused by a beam system. A zone of unfused powder extends beyond boundaries of the 2D slice area.

FIG. 6C is similar to FIG. 6B except that a contour of support material has been dispensed proximate or overlapping with the zone of unfused powder.

FIG. 7 is a side view of a cross section AA′ through the lateral view of FIG. 6C.

### SUMMARY

In a first aspect of the disclosure, a three-dimensional (3D) printing system for manufacturing a three-dimensional (3D) article includes a support powder dispenser containing support powder, a metal powder dispenser containing metal powder, a build plate coupled to a vertical positioning system, a beam system, and a controller. The controller is configured to (1) receive information defining a two-dimensional (2D) slice of the 3D article defining a fused region and having a slice boundary, (2) operate the vertical positioning system to position the build plate to receive a new layer of metal powder, (3) operate the metal powder dispenser to dispense the new layer of metal powder, the new layer of metal powder spanning the 2D slice and extending beyond the slice boundary to define a zone of unfused powder having a lateral width that is at least an offset distance D, (4) operate the beam system to selectively fuse the new layer of powder over an area corresponding to the 2D slice and leaving the zone of unfused powder, (5) operate the support powder dispenser to dispense a bounding contour of support powder proximate to or overlapping the zone of unfused powder, and repeat receiving information and operation of the support powder dispenser, the vertical positioning system, the metal powder dispenser, and the beam system to complete fabrication of the 3D article. The order of certain steps can vary. Step (5) can be performed before or after dispensing and fusing layer(s) of metal.

By dispensing bounding contours of support powder, an amount of metal powder required to fabricate an article is minimized. This is particularly important for systems that can produce very large metal articles because not all of the build volume needs to be filled with metal powder. Also, the offset between the bounding contour and the slice boundary allows the beam system to define an outer boundary of each slice without any defects caused by the support powder being embedded into a surface of the 3D article. In some embodiments, the slice boundary can include inner and outer slice boundaries.

In one implementation, the bounding contour of support powder has a vertical thickness that is at least twice the vertical thickness of the metal powder layer. This allows two or more layers of metal powder to be dispensed for each bounding contour of support powder that is dispensed. This reduces a time required to fabricate the 3D article. For some systems, there are N layers of metal powder dispensed for an individual bounding contour being dispensed. N can be 2, 3, 4, 5, or more, depending upon factors such as the avalanche angle of the support powder. Thus, steps (3)-(5) are repeated N times for each time for an individual time that step (2) is performed.

In another implementation, the support powder is a sand material. The sand material can include one or more of zircon (zircon silicate) particles or silicon dioxide particles. In a particular implementation, the support material consists of zircon particles.

In yet another implementation the support powder has a first avalanche angle. The metal powder has a second avalanche angle. The first avalanche angle is greater than the second avalanche angle. The first avalanche angle can be at least 40 degrees which maximizes a height to width ratio of a dispensed bounding contour. The second avalanche angle is lower than the first avalanche angle to improve uniformity and surface quality of a dispensed metal powder layer.

In a further implementation, the support powder consists of particles having a first average particle size. The metal powder consists of particles having a second average particle size. The first average particle size can be at least twice the second average particle size. The first average particle size can be at least three times the second average particle size. The first average particle size can be at least four times the second average particle size. A large difference in particle size between the support powder and the metal powder facilitates separation of the support powder from the metal powder. This in turn allows the metal powder to be recycled.

In a yet further implementation, the bounding contour of support powder includes an outer bounding contour that laterally surrounds the 2D slice and at least one inner bounding contour that is laterally surrounded by the 2D slice.

In a second aspect of the disclosure, a method of manufacturing a 3D article includes providing and operating a 3D printing system. The 3D printing system includes a support powder dispenser containing support powder, a metal powder dispenser containing metal powder, a build plate coupled to a vertical positioning system, a beam system, and a controller. Operating the 3D printing system includes (1) receiving information defining a two-dimensional (2D) slice of the 3D article defining a fused region and having a slice boundary, (2) operating the vertical positioning system to position the build plate to receive a new layer of metal powder, (3) operating the metal powder dispenser to dispense the new layer of metal powder, the new layer of metal powder spanning the 2D slice and extending beyond the slice boundary to define a zone of unfused powder having a lateral width that is at least an offset distance D, (4) operating the beam system to selectively fuse the new layer of powder over an area corresponding to the 2D slice and leaving the zone of unfused powder, (5) operating the support powder dispenser to dispense a bounding contour of support powder proximate to or overlapping the zone of unfused powder, and repeating receiving information and operation of the support powder dispenser, the vertical positioning system, the metal powder dispenser, and the beam system to complete fabrication of the 3D article.

In a third aspect of the disclosure, a non-transient storage media stores software instructions for manufacturing a 3D article. When executed by a processor, the software instructions perform at least the following steps: (1) receive information defining a two-dimensional (2D) slice of the 3D article defining a fused region and having a slice boundary, (2) operate a vertical positioning system to position a build plate to receive a new layer of metal powder, (3) operate a metal powder dispenser to dispense the new layer of metal powder, the new layer of metal powder spanning the 2D slice and extending beyond the slice boundary to define a zone of unfused powder having a lateral width that is at least an offset distance D, (4) operate a beam system to selectively fuse the new layer of powder over an area corresponding to the 2D slice and leaving the zone of unfused powder, (5) operate a support powder dispenser to dispense a bounding contour of support powder proximate to or overlapping the zone of unfused powder, and repeat receiving information and operation of the support powder dispenser, the vertical positioning system, the metal powder dispenser, and the beam system to complete fabrication of the 3D article.

### DETAILED DESCRIPTION OF THE PREFERRED EMBODIMENTS

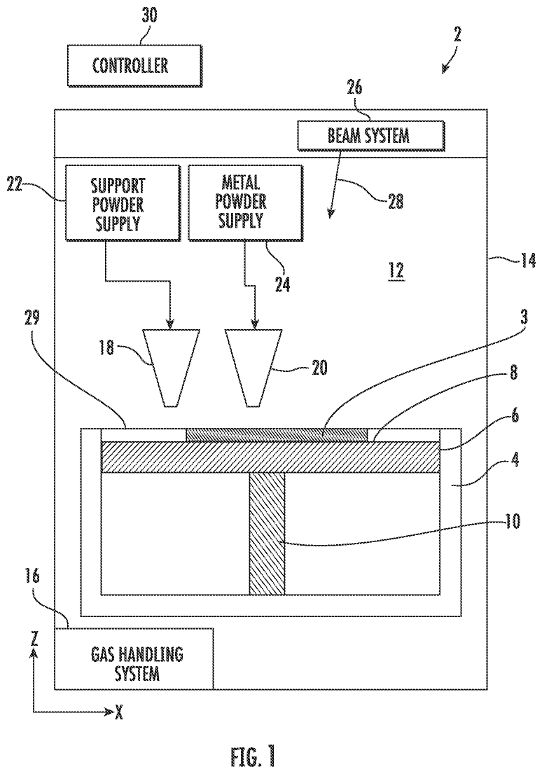

FIG. 1 is a schematic diagram depicting an embodiment of a three-dimensional (3D) printing system 2 for manufacturing a three-dimensional (3D) article 3 from metal powder. In describing 3D printing system 2, mutually orthogonal axes X, Y and Z can be used. Axes X and Y are lateral axes that are generally horizontal. Axis Z is a vertical axis that is generally aligned with a gravitational reference. By “generally” it is intended to be so by design but may vary due to manufacturing or other tolerances.

System 1 includes a build box 4 containing a build plate 6. The build plate 6 has an upper surface 8 and is coupled to a vertical positioning system 10. The build box 4 is configured to contain powder (not shown). The build box 4 is contained within chamber 12 surrounded by a housing 14. A gas handling system 16 is configured to evacuate air (including oxygen) from the chamber 12 and to backfill the chamber 12 with a non-oxidizing gas such as nitrogen or argon.

Within the chamber 12 is a first powder dispenser 18 and a second powder dispenser 20. The first powder dispenser 18 (support powder dispenser 18) contains support powder and is either continuously or intermittently coupled to a support powder supply 22. The support powder can be a sand material such as zircon (zircon silicate) powder. In an illustrative embodiment, the sand or zircon consists of particles that are at least about 100 microns in size. In some embodiments, the particles can be at least about 150 or 200 or 250 microns in size. The grains can have a size that falls within a range or 100 to 300 microns in size, or 150 to 200 microns in size. Other sizes are possible.

When referring to a size of a grain or particle, the “size” is a linear dimension. If the particle is a sphere, then the size is the diameter. For irregular or non-spherical particles, the “size” can be approximately equal to a diameter of a solid sphere having an equivalent mass as the particle.

The second particle dispenser 20 (metal powder dispenser 20) contains metal powder and is either continuously or intermittently coupled to a metal powder supply 24. The metal powder can be elemental or an alloy. Examples of metal powder include titanium and stainless steel but there are numerous other possibilities. The metal powder consists of particles that can have a size of about 10 to 60 microns. More particularly, the metal powder particles can have a size range between 20 and 50 microns. Other ranges of particle sizes are possible.

It is preferable that the support powder particle size range and the metal powder size range are non-overlapping to facilitate separation of support powder and metal powder. Preferably, the average support powder particle size is at least 100%, 150%, 200%, 250%, or 300% larger than the average metal particle size. The larger the difference, the greater the ease in separating mixed powders. Being able to separate the powders facilitates recycling the metal powder, which can be very expensive.

In some embodiments, there may be more than one metal powder dispenser 20 to allow more than one type of metal powder to be dispensed. Various types of powder dispensers can be utilized for powder dispensers 18 and 20. An example of a powder dispenser is described in U.S. Pat. No. 10,576,542. Other powder dispenser designs can also be used in system 2.

The particle dispensers 18 and 20 are configured to dispense contours of powder. A contour has a width, is flat on top, and has sloped edges whose slope depends upon an angle of repose or avalanche angle of the powder. The contours can have any desired geometric shape determined by motion control of moving the powder dispensers 18 and 20 over the upper surface 8. The motion control can be provided by a mechanical gantry system which is a known way of providing lateral and vertical motion for dispensing systems.

System 2 includes a beam system 26 configured to generate a beam 28 for selectively fusing layers of dispensed metal powder. In an illustrative embodiment, the beam system 26 includes a plurality of high power lasers for generating radiation beams individually having an optical power layer of at least 100 watts, at least 500 watts, or about 1000 watts or more. The beam system 26 can include optics for individually steering the radiation beams across a build plane 29 that is generally coincident with an upper surface of a new layer of metal powder. The build plane 29 is defined by a lateral area in X and Y and a Z-height. The lateral area of the build plane 29 is defined by lateral scan limits for beam system 26 in fabricating the 3D article 3. Build plane 29 generally has a Z coordinate corresponding to an optimal focus range for the beam system 26. In alternative embodiments, the beam system 26 can generate electron beams, particle beams, or a hybrid mixture of different beam types.

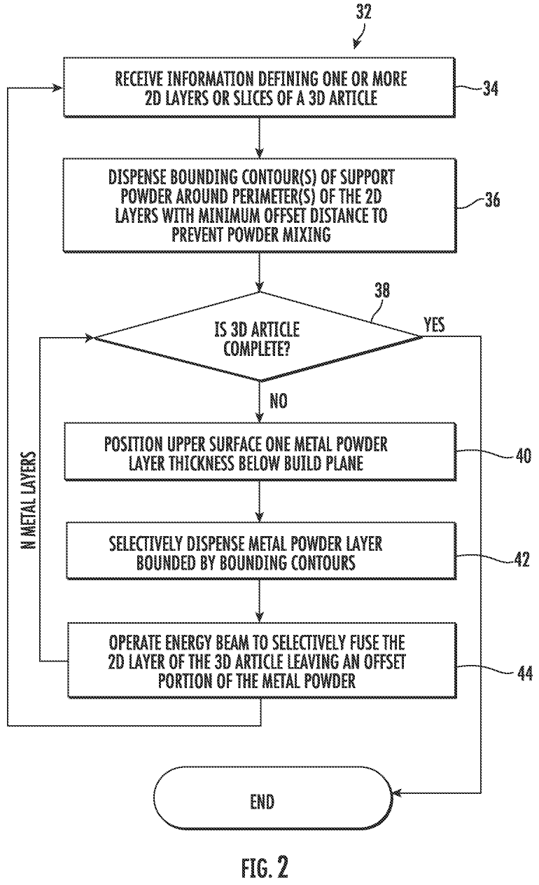

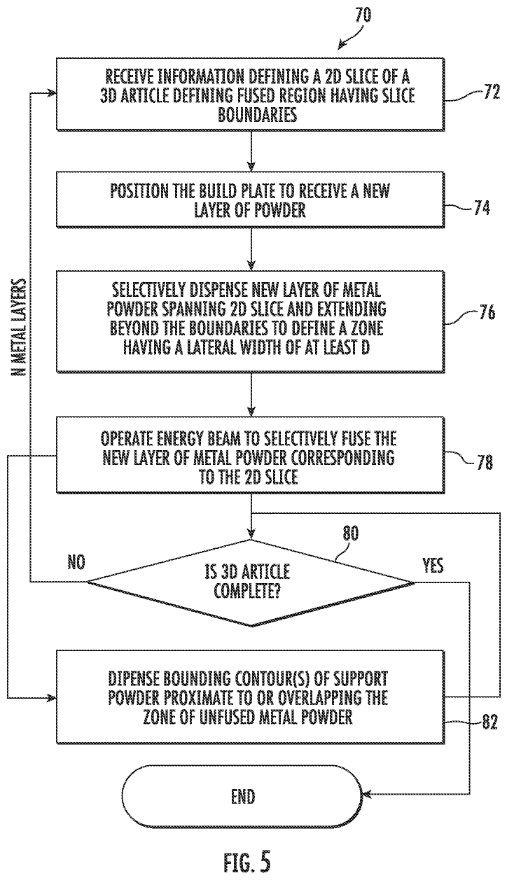

A controller 30 is controllably coupled to operate the vertical positioning system 10, the gas handling system 16, the powder dispensers 18 and 20, the powder supplies 22 and 24, the beam system 26, and other portions of the 3D printing system 2. The controller 30 includes a processor coupled to a non-volatile or non-transient information storage device. The information storage device stores software instructions for operating some or all controllable portions of the 3D printing system 2. When executed by the processor, the software instruction can operate the 3D printing system 2 and perform a method to manufacture a 3D article including the steps of: (1) Operate the gas handling system 16 to provide a non-oxidizing gaseous environment inside chamber 12 including argon or nitrogen, (2) operate the vertical positioning system to position the upper surface 8 (or later an upper surface of metal powder) proximate to the build plane 29 (to be generally coincident to an upper surface of the most recently dispensed layer of metal powder), (3) operate the support powder dispenser 18 to dispense one or more contours of support powder upon the upper surface 8, (4) operate the metal powder dispenser to dispense a layer of metal powder within one or more regions bounded by the one or more contours of support powder, (5) operate the beam system to selectively fuse the most recently dispense layer of metal powder to define a layer of the 3D article, and repeat steps (2)-(5) to complete fabrication of the 3D article. One embodiment of this method is described with respect to the method 32 of FIG. 2. In some embodiments, step (3) occurs after step (5) as in method 70 of FIG. 5.

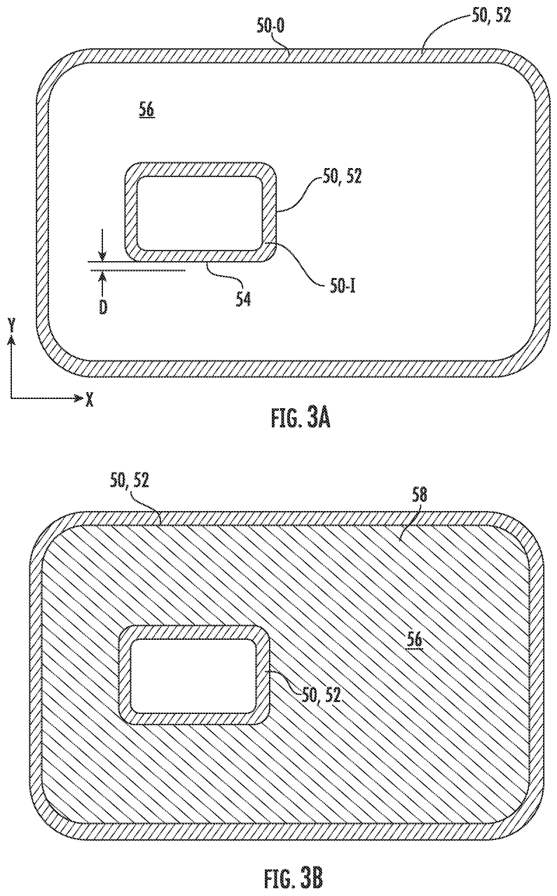

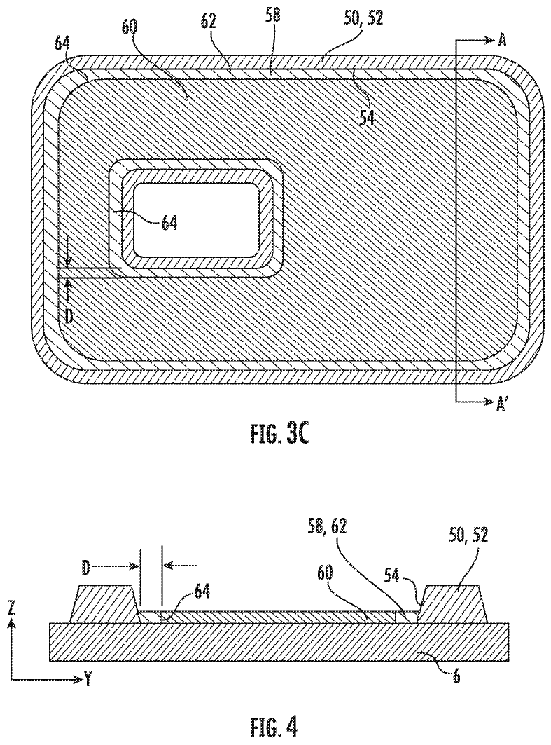

FIG. 2 is a flowchart depicting a first embodiment of a method or process 32 for fabricating a 3D article. Controller 30 is configured to operate components of system 2 to perform method 32 through the execution of software instructions. FIGS. 3A-3C and 4 illustrate steps of the method 32. FIGS. 3A-3C are lateral views that illustrate a dispensed and selectively fused pattern of powders. FIG. 4 is a side view of a cross section AA′ through the lateral view of FIG. 3C.

According to 34, controller 30 receives information defining a plurality N (one or more) of layers or slices of the 3D article. According to 36, the controller 30 operates the support powder dispenser 18 to dispense at least one bounding contour 50 of support powder 52. (See FIG. 3A) The bounding contour(s) 50 of support powder 52 surround 2D layers or slices of the 3D article. The bounding contours 50 individually have a bounding surface 54 that faces an interior area 56 that will contain a 2D slice. There is an offset distance D between the bounding surface 54 and the 2D slice (not yet shown but shown in subsequent figures). In the illustrated embodiment, the bounding contours 50 include an outer bounding contour 50-O and an inner bounding contour 50-I. The interior area 56 is the lateral area between the outer 50-O and inner 50-I bounding contours.

According to 38, a determination is made as to whether the 3D article fabrication is complete. If yes, then the process 32 ends (which would indicate that steps 34 and 36 did not take place before step 38). Otherwise, the process 32 moves to step 40. According to 40, the controller 30 operates the vertical positioning system 10 to position the upper surface 8 (of the build plate 6 or an upper surface of partially fused powder) one layer metal layer thickness below the build plane 29.

According to 42, the controller 30 operates the metal powder dispenser 20 to dispense a layer of unfused metal powder 58 over the interior area 56 which is bounded by the bounding surface(s) 54. (See FIG. 3B) According to 44, the controller 30 operates the beam system 26 to selectively fuse the metal powder 58 to define an area of fused metal powder 60. (See FIGS. 3C, 4) The area of fused metal powder 60 corresponds to and defines the layer or slice of the 3D article. Between the fused metal powder 60 and a bounding contour 50 is a zone 62 of unfused metal powder 58. The zone 62 has a width equal to the offset distance D.

Preferably, a vertical thickness of the bounding contour 50 is greater than a vertical thickness of a metal powder layer as illustrated in FIG. 4. This reduces a number of times step 36 needs to be repeated while forming the 3D article. Referring to FIG. 2, the process 32 loops from step 44 back to step 38 up to N times (until fabrication is complete). After N metal layers are formed, the process then loops from step 44 to step 34 or step 36 to form a new support contour 50.

Preferably, the bounding contour 50 has a vertical thickness that is at least twice a vertical thickness of a single layer of fused metal powder 60. The bounding contour can be at least two times, at least three times, at least four times, at least five times, or more than five times the thickness of a layer of fused metal powder 60. A single layer of metal powder can be 10 to 60 microns in thickness or about 20 to 50 microns in thickness.

What partially limits a thickness of one bounding contour 50 layer is an angle of repose or avalanche angle of the support powder 52. The angle of repose is the maximum stable angle with respect to a lateral or horizontal axis. The avalanche angle is an angle relative to the horizontal above which the slope loses stability and begins to slide. Typically, the avalanche angle is about 2 degrees greater than the angle of repose. Preferably the support powder 52 has an avalanche angle of at least 40 degrees relative to the horizontal. Also, it is preferred that the avalanche angle of the unfused metal powder 58 is less than that of the support powder 52.

The offset distance D is minimized to improve efficiency but should be large enough to prevent fused metal powder 60 from overlapping the bounding contour 50. This improves quality of a boundary 64 of the fused metal powder 60. Overlap of the bounding contour 50 with the boundary 64 can result in defects in the boundary 64 such as pits and embedded particles of the support powder 52.

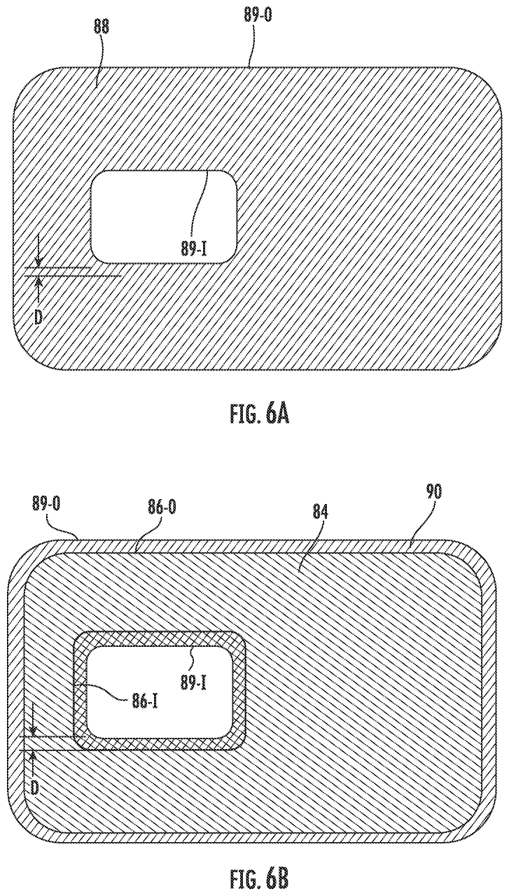

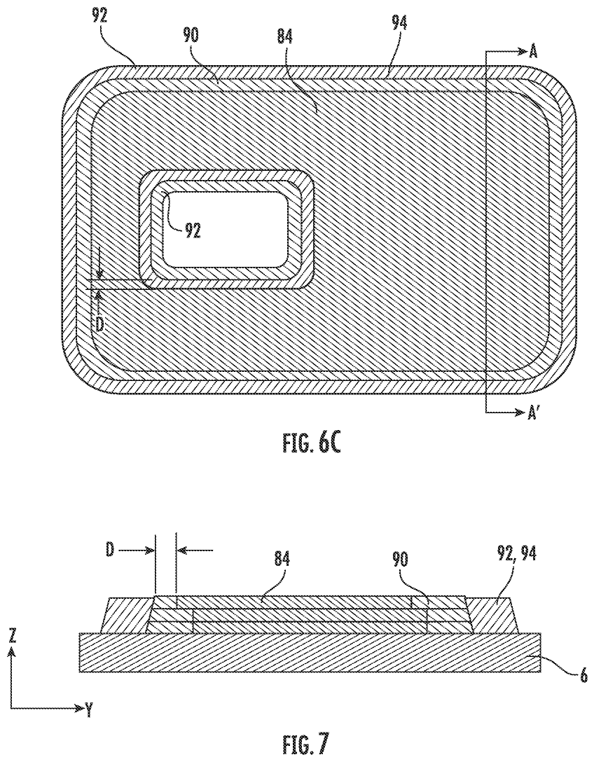

FIG. 5 is a flowchart depicting a second embodiment of a method or process 70 for fabricating a 3D article. Controller 30 is configured to operate components of system 2 to perform method 70 through the execution of software instructions FIGS. 6A-6C and 7 illustrate steps of the method 70. FIGS. 6A-6C are lateral views that illustrate a dispensed and selectively fused pattern of powders. FIG. 7 is a side view of a cross section AA′ through the lateral view of FIG. 6C. Method 70 is very similar to method 32 except that an order of certain steps is changed.

According to 72, the controller 30 (or a processor within the controller 30) receives information defining a two dimensional (2D) slice 84 (FIG. 6B) of a three-dimensional (3D) article. The 2D slice defines a 2D area of metal powder to be selectively fused including boundaries 86 that bound the area to be fused. In the illustrated embodiment of FIG. 6B, the boundaries include an outer boundary 86-O and an inner boundary 86-I.

According to 74, the vertical positioning system 10 is operated to position the build plate 6 to receive a new layer of powder 88. The position assures that an upper surface of the new layer of powder 88 will be positioned at the build plane 29 which is a focal plane for the beam system 26.

According to 76, the metal powder dispenser 20 is operated to dispense the new layer of metal powder 88. The new layer of metal powder 88 spans the 2D slice 86 and extends beyond the boundaries 86 to define a zone 90 of unfused powder having a lateral width that is at least an offset distance D. FIG. 6A illustrates a new layer of metal powder having boundaries 89 including an outer boundary 89-O and an inner boundary 89-I.

According to 78, the beam system 26 is operated to selectively fuse the new layer of metal over the 2D area of metal powder that corresponds to and is laterally the same as the 2D slice 84. Remaining after step 78 is still the zone 90 of unfused powder. The zone 90 has a minimum width of D. D is referred to as an “offset distance”.

According to 80, a determination is made to see if the 3D article fabrication is completed. If YES, then method 70 ends. If NO, then the process loops back to step 72.

Steps 72-80 are repeated N times. N is at least equal to one. After N repeats, the process moves to step 82.

According to 82, the support powder dispenser 22 is operated to dispense a contour 92 of support powder 94. The contour 92 of support powder 94 is dispensed proximate to or overlapping with the zone 90 of unfused powder. Then the process loops back to 80.

FIG. 7 is a cross-sectional view taken through AA′ of FIG. 6C. In the illustrated embodiment, three layers of metal powder 88 are deposited and selectively fused before a contour 92 is deposited. For all of the layers a minimum offset distance D is maintained between the contour 92 of support powder 94 and the 2D slice 84 of fused powder.

The specific embodiments and applications thereof described above are for illustrative purposes only and do not preclude modifications and variations encompassed by the scope of the following claims. For example, there are a number of different operable sequence variations including methods 32 and 70 that can still be within the scope of the claims.

What is claimed:

1. A three-dimensional (3D) printing system for manufacturing a three-dimensional (3D) article comprising:
a support powder dispenser containing support powder;
a metal powder dispenser containing metal powder;
a build plate coupled to a vertical positioning system;
a beam system; and
a controller configured to:
(1) receive information defining a two-dimensional (2D) slice of the 3D article defining a fused region and having a slice boundary;
(2) operate the vertical positioning system to position the build plate to receive a new layer of metal powder;
(3) operate the metal powder dispenser to dispense the new layer of metal powder, the new layer of metal powder spanning the 2D slice and extending beyond the slice boundary to define a zone of unfused powder having a lateral width that is at least an offset distance D;
(4) operate the beam system to selectively fuse the new layer of powder over an area corresponding to the 2D slice and leaving the zone of unfused powder;
(5) operate the support powder dispenser to dispense a bounding contour of support powder proximate to or overlapping the zone of unfused powder; and
repeat receiving information and operation of the support powder dispenser, the vertical positioning system, the metal powder dispenser, and the beam system to complete fabrication of the 3D article.

2. The three-dimensional printer of claim 1 wherein steps (1)-(4) are repeated N times, N is greater than 1, before performing step (5).

3. The three-dimensional printer of claim 1 wherein step (5) occurs before steps (1)-(4) are performed, steps (1)-(4) are repeated N times before repeating step (5), N is greater than 1.

4. The three-dimensional printer of claim 1 wherein the support powder includes one or more of sand particles, zircon particles, and silicon dioxide particles.

5. The three-dimensional printer of claim 1 wherein the support powder has a first avalanche angle, the metal powder has a second avalanche angle, the first avalanche angle is greater than the second avalanche angle.

6. The three-dimensional printer of claim 1 wherein the support powder has an avalanche angle of at least 40 degrees.

7. The three-dimensional printer of claim 1 wherein the support powder consists of particles having a first average particle size, the metal powder consists of particles having a second average particle size, the first average particle size is at least two times the second average particle size.

8. The three-dimensional printer of claim 1 wherein the bounding contour of support powder includes an outer bounding contour that laterally surrounds the 2D slice and at least one inner bounding contour that is laterally surrounded by the 2D slice.

9. A method of manufacturing a 3D article comprising:
providing a 3D printing system including:
a support powder dispenser containing support powder;
a metal powder dispenser containing metal powder;
a build plate coupled to a vertical positioning system; and
a beam system;
(1) receiving information defining a two-dimensional (2D) slice of the 3D article defining a fused region and a slice boundary;
(2) operating the vertical positioning system to position the build plate to receive a new layer of metal powder;
(3) operating the metal powder dispenser to dispense the new layer of metal powder, the new layer of metal powder spanning the 2D slice and extending beyond the slice boundary to define a zone of unfused powder having a lateral width that is at least an offset distance D;
(4) operating the beam system to selectively fuse the new layer of powder over an area corresponding to the 2D slice and leaving the zone of unfused powder;
(5) operating the support powder dispenser to dispense a bounding contour of support powder proximate to or overlapping the zone of unfused powder; and
repeating receiving information and operation of the support powder dispenser, the vertical positioning system, the metal powder dispenser, and the beam system to complete fabrication of the 3D article.

10. The method of claim 9 wherein steps (1)-(4) are repeated N times, N is greater than 1, before performing step (5).

11. The method of claim 9 wherein step (5) occurs before steps (1)-(4) are performed, steps (1)-(4) are repeated N times before repeating step (5), N is greater than 1.

12. The method of claim 9 wherein the support powder includes one or more of sand particles, zircon particles, and silicon dioxide particles.

13. The method of claim 9 wherein the support powder has a first avalanche angle, the metal powder has a second avalanche angle, the first avalanche angle is greater than the second avalanche angle.

14. The method of claim 9 wherein the support powder has an avalanche angle of at least 40 degrees.

15. The method of claim 9 wherein the support powder consists of particles having a first average particle size, the metal powder consists of particles having a second average particle size, the first average particle size is at least two times the second average particle size.

16. The method of claim 9 wherein the support powder consists of particles having a first average particle size, the metal powder consists of particles having a second average particle size, the first average particle size is at least three times the second average particle size.

17. The method of claim 9 wherein the bounding contour of support powder includes an outer bounding contour that laterally surrounds the 2D slice and at least one inner bounding contour that is laterally surrounded by the 2D slice.

18. A non-transient storage media storing software instructions for manufacturing a 3D article, that when executed by a processor, perform the following steps:
(1) receive information defining a two-dimensional (2D) slice of the 3D article defining a fused region and having boundaries;
(2) operate a vertical positioning system to position a build plate to receive a new layer of metal powder;
(3) operate a metal powder dispenser to dispense the new layer of metal powder, the new layer of metal powder spanning the 2D slice and extending beyond the boundaries to define a zone of unfused powder having a lateral width that is at least an offset distance D;
(4) operate a beam system to selectively fuse the new layer of powder over an area corresponding to the 2D slice and leaving the zone of unfused powder;
(5) operate a support powder dispenser to dispense a bounding contour of support powder proximate to or overlapping the zone of unfused powder; and
repeat receiving information and operation of the support powder dispenser, the vertical positioning system, the metal powder dispenser, and the beam system to complete fabrication of the 3D article.

19. The non-transient storage media of claim 18 wherein steps (1)-(4) are repeated N times, N is greater than 1, before performing step (5).

20. The non-transient storage media of claim 18 wherein step (5) occurs before steps (1)-(4) are performed, steps (1)-(4) are repeated N times before repeating step (5), N is greater than 1.
